(19) United States
(12) Patent Application Publication
(10) Pub. No.: US 2012/0158598 A1
(43) Pub. Date: Jun. 21, 2012

(54) Modeling and mapping comparable properties

(75) Inventors: Alexei M. Kisselev, Burke, VA (US); Yong Chen, Potomac, MD (US); Eric Rosenblatt, Derwood, MD (US); Megan C. Berry, Rockville, MD (US); Patria S. Kunde, McLean, VA (US)

(73) Assignee: Fannie Mae, Washington, DC (US)

(21) Appl. No.: 12/926,896

(22) Filed: Dec. 16, 2010

(51) Int. Cl. G06Q 50/00; G09G 5/00

(52) U.S. Cl. 705/306; 345/634

(57) ABSTRACT

Modeling and mapping appropriate comparable properties comprises accessing property data corresponding to a geographical area, and then weighting comparable properties based upon the appropriateness of each of the plurality of comparable properties as comparables for a subject property. For example, the weighting may be based upon economic distance from the subject property, geographic distance from the subject property, and age of transaction. Using this information, a map image of the geographical area is displayed, with indicators on the map image indicative of the subject property and at least one of the comparable properties.

### BACKGROUND OF THE INVENTION

1. Field of the Invention

This application relates to modeling and mapping comparable properties.

2. Description of the Related Art

Although the technical field of home mortgage financing currently practices statistical modeling to estimate the market value of a single family home, current models are limited.

Appraisal risk models are intended to rank appraisals by their risk and set thresholds for rejection or acceptance of appraisals, and, when an appraisal is based on a sales comparison approach, which will often include more than 3 properties that are comparable to a target property (or comps), there may be more than 1000 comps available based on either public record data or listing data.

The pool of comps is often too unwieldy to use in assessing the accuracy and propriety of appraisal work. Additionally, the comp modeling results may produce raw data that is of little use to the user. Still further, the comp modeling results are often provided solely in text form. While this information could be manually correlated to a map, this is cumbersome and unwieldy as well.

What is needed are improved modeling of comparable properties, as well as tools useful for reviewing and assessing a pool of comparable properties against a subject property, to assist in assessing the valuation of the subject property.

### SUMMARY OF THE INVENTION

According to one aspect, modeling and mapping appropriate comparable properties comprises accessing property data corresponding to a geographical area, and then weighting comparable properties based upon the appropriateness of each of the plurality of comparable properties as comparables for a subject property. For example, the weighting may be based upon economic distance from the subject property, geographic distance from the subject property, and age of transaction. Using this information, a map image of the geographical area is displayed, with indicators on the map image indicative of the subject property and at least one of the comparable properties.

In one example, the property data is accessed and a regression models the relationship between price and explanatory variables. A subject property and a pool of comparable properties are then identified, and a set of value adjustments for each of the comparable properties is determined based upon differences in the explanatory variables between the subject property and the respective comparable properties. The economic distance is then determined between the subject property and each of the comparable properties. The economic distance may be constituted as a quantified value determined from the set of value adjustments for each respective comparable property. Following this weighting may be performed using the economic distance and other factors, and mapping and displaying comparable properties is provided.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIGS. 1A-B are block diagrams illustrating examples of systems in which a comparable property modeling and mapping application operates.

FIG. 2 is a flow diagram illustrating an example of a process for modeling comparable properties.

FIG. 3 is a flow diagram illustrating an example of modeling and mapping comparable properties.

FIG. 4 is a block diagram illustrating an example of a comparable property modeling and mapping application.

FIGS. 5A-D are display diagrams illustrating examples of map images and corresponding property grid data.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

According to one aspect, the present invention models comparable properties and renders map images and associated information useful for analyzing comparable properties.

Modeling and mapping appropriate comparable properties may comprise accessing property data corresponding to a geographical area, and then weighting comparable properties based upon the appropriateness of each of the plurality of comparable properties as comparables for a subject property. For example, the weighting may be based upon economic distance from the subject property, geographic distance from the subject property, and age of transaction. Using this information, a map image of the geographical area is displayed, with indicators on the map image for the subject property and corresponding comparable properties.

In one example, the property data is accessed and a regression models the relationship between price and explanatory variables. For example, a hedonic regression is performed at a geographic level (e.g., county) sufficient to produce reliable results. A pool of comparables is identified, such as by initial exclusion rules based upon distance from and other factors in relation to a subject property. A set of adjustments for each comparable is determined using adjustment factors drawn from the regression analysis. These adjustments are then used to derive an economic distance between each comparable and the subject property. For example, the economic distance may be a value indicative of the estimated price difference between a comp and the subject that is determined from the set of adjustments for that comp. The comparables are weighted according to the economic distance, physical distance and time (of sale) between the comparable and the subject property.

A map image is displayed to illustrate the geographic distribution of the subject property and the comparable properties. An associated grid details information about the subject and comparable properties. The grid can be sorted according to a variety of property and other characteristics, and operates in conjunction with the map image to ease review of the comparables and corresponding criteria. The map image may be variously scaled and updates to show the subject property and corresponding comparables in the viewed range, and interacts with the grid (e.g. cursor overlay on comparable property in the map image allows highlighting of additional data in the grid).

(i) Hedonic Equation

One example of a hedonic equation is described below. In the hedonic equation, the dependent variable is sale price and the explanatory variables can include the physical characteristics, such as gross living area, lot size, age, number of bedrooms and or bathrooms, as well as location specific effects, time of sale specific effects, property condition effect (or a proxy thereof). This is merely an example of one possible hedonic model. The ordinarily skilled artisan will readily recognize that various different variables may be used in conjunction with the present invention.

In this example, the dependent variable is the logged sale price. The explanatory variables are:

(1) Four continuous property characteristics:

(a) log of gross living area (GLA),

(b) log of Lot Size,

(c) log of Age, and

(d) Number of Bathrooms; and

(2) Three fixed effect variables:

(a) location fixed effect (e.g., by Census Block Group (CBG));

(b) Time fixed effect (e.g., measured by 3-month periods (quarters) counting back from the estimation date); and

(c) Foreclosure status fixed effect, which captures the maintenance condition and possible REO discount.

The exemplary equation (Eq. 1) is as follows:

$$ln ( p ) = {β}_{gla} \cdot ln ( GLA ) + {β}_{lot} \cdot ln ( LOT ) + {β}_{age} \cdot ln ( AGE ) + {β}_{bath} \cdot BATH ++ {\sum }_{i = 1}^{{N}_{CBG}} {LOC}_{i}^{CBG} + {\sum }_{j = 1}^{{N}_{QTR}} {TIME}_{j} + {\sum }_{k = \{ 0 , 1 \}} {FCL}_{k} + ɛ \qquad ( Eq . 1 )$$

The above equation is offered as an example, and as noted, there may be departures. For example, although CBG is used as the location fixed effect, other examples may include Census Tract or other units of geographical area. Additionally, months may be used in lieu of quarters, or other periods may be used regarding the time fixed effect. These and other variations may be used for the explanatory variables.

Additionally, although the county may be used for the relatively large geographic area for which the regression analysis is performed, other areas such as a multi-county area, state, metropolitan statistical area, or others may be used. Still further, some hedonic models may omit or add different explanatory variables.

(ii) Exclusion Rules

Comparable selection rules are then used to narrow the pool of comps to exclude the properties which are determined to be insufficiently similar to the subject.

A comparable property should be located in a relative vicinity of the subject and should be sold relatively recently; it should also be of similar size and age and sit on a commensurate parcel of land. The “N” comparables that pass through the exclusion rules are used for further analysis and value prediction.

For example, the following rules may be used to exclude comparables pursuant to narrowing the pool:

(1) Neighborhood: comps must be located in the Census Tract of the subject and its immediate neighboring tracts;

(2) Time: comps must be sales within twelve months of the effective date of appraisal or sale;

$$\frac{2}{3} \leq \frac{{GLA}_{S}}{{GLA}_{C}} \leq \frac{3}{2}$$

(3) GLA must be within a defined range, for example:

(4) Age similarity may be determined according to the following Table 1:

TABLE 1

| Subject Age | 0-2 | 3-5 | 6-10 | 11-20 | 21-40 | 41-65 | 65+ |
|---|---|---|---|---|---|---|---|
| Acceptable Comp Age | 0-5 | 0-10 | 2-20 | 5-40 | 11-65 | 15-80 | 45+ |

(5) Lot size similarity may be determined according to the following Table 2:

TABLE 2

| | | | | |
|---|---|---|---|---|
| Subject Lot size | <2000 | 2000 - 4000 | 4000 sqft - 3 | >3 acres |
| | sqft | sqft | acres | |
| Acceptable Comp Lot | 1 - 4000 sqft | 1 - 8000 sqft | $\frac{2}{5} \leq \frac{{LOT}_{S}}{{LOT}_{C}} \leq \frac{5}{2}$ | >1 acre |

These exclusion rules are provided by way of example. There may be a set of exclusion rules that add variables, that omit one or more the described variables, or that use different thresholds or ranges.

(iii) Adjustment of Comps

Given the pool of comps selected by the model, the sale price of each comp may then be adjusted to reflect the difference between a given comp and the subject in each of the characteristics used in the hedonic price equation.

For example, individual adjustments are given by the following set of equations (2):

A_{gla}=exp└(ln(GLA_{S})−ln(GLA_{C}))·β_{gla}┘;

Aₗₒₜ=exp[(ln(LOT_{S})−ln(LOT_{C}))·βₗₒₜ];

A_{age}=exp└(ln(AGE_{S})−ln(AGE_{C}))·β_{age}┘;

A_{bath}=exp└(BATH_{S}−BATH_{C})·β_{age}┘;

A_{loc}=exp[LOC_{S}−LOC_{C}];

Aₜᵢₘₑ=exp[TIME_{S}−TIME_{C}]; and

A_{fcl}=exp[FCL_{S}−FCL_{C}], (Eq. 2)

where coefficients βgla, βlot, βage, βbath, LOC, TIME, FCL are obtained from the hedonic price equation described above. Hence, the adjusted price of the comparable sales is summarized as:

$${p}_{C}^{adj} = {p}_{C} \cdot {\prod }_{i ∈ \{ gla , lot , age , bath , loc , time , fcl \}} {A}_{i} = {p}_{C} \cdot {A}_{TOTAL} \qquad ( Eq . 3 )$$

(iv) Weighting of Comps and Value Prediction

Because of unknown neighborhood boundaries and potentially missing data, the pool of comparables will likely include more than are necessary for the best value prediction in most markets. The adjustments described above can be quite large given the differences between the subject property and comparable properties. Accordingly, rank ordering and weighting are also useful for the purpose of value prediction.

The economic distance D_{eco} between the subject property and a given comp may be describe as a function of the differences between them as measured in dollar value for a variety of characteristics, according to the adjustment factors described above.

Specifically, the economic distance may be defined as a Euclidean norm of individual percent adjustments for all characteristics used in the hedonic equation:

$${D}_{SC}^{eco} = \sqrt{{\sum }_{i ∈ \{ gla , lot , age , bath , loc , time , fcl \}} {( {A}_{i} - 1 )}^{2}} \qquad ( Eq . 4 )$$

The comps are then weighted. Properties more similar to the subject in terms of physical characteristics, location, and time of sale are presumed better comparables and thus are preferably accorded more weight in the prediction of the subject property value. Accordingly, the weight of a comp may be defined as a function inversely proportional to the economic distance, geographic distance and the age of sale.

For example, comp weight may be defined as:

$${w}_{C} = \frac{1}{{D}_{SC}^{eco} \cdot {D}_{SC}^{geo} \cdot {dT}_{SC}} \qquad ( Eq . 5 )$$

where D_{geo} is a measure of a geographic distance between the comp and the subject, defined as a piece-wise function:

$${D}_{SC}^{geo} = \{ \begin{matrix}0.1 & if {d}_{SC} < 0.1 mi \\ {d}_{SC} & if 0.1 mi \leq {d}_{SC} \leq 1.0 mi \\ 1.0 + \sqrt{{d}_{SC} - 1.0} & if {d}_{SC} > 1.0 mi ,\end{matrix} \qquad ( Eq . 6 )$$

and dT is a down-weighting age of comp sale factor

$${dT}_{SC} = \{ \begin{matrix}1.00 & if ( 0 , 90 ] days \\ 1.25 & if ( 90 , 180 ] days \\ 2.00 & if ( 180 , 270 ] days \\ 2.50 & if ( 270 , 365 ] days .\end{matrix} \qquad ( Eq . 7 )$$

Comps with higher weight receive higher rank and consequently contribute more value to the final prediction, since the predicted value of the subject property based on comparable sales model is given by the weighted average of the adjusted price of all comps:

$${\hat{p}}_{S} = \frac{{\sum }_{C = 1}^{{N}_{COMPS}} {w}_{C} \cdot {p}_{C}^{adj}}{{\sum }_{C = 1}^{{N}_{COMPS}} {w}_{C}} \qquad ( Eq . 8 )$$

As can be seen from the above, the separate weighting following the determination of the adjustment factors allows added flexibility in prescribing what constitutes a good comparable property. Thus, for example, policy factors such as those for age of sale data or location may be separately instituted in the weighting process. Although one example is illustrated it should be understood that the artisan will be free to design the weighting and other factors as necessary.

According to another aspect, mapping and analytical tools that implement the comparable model are provided. Mapping features allow the subject property and comparable properties to be concurrently displayed. Additionally, a table or grid of data for the subject properties is concurrently displayable so that the list of comparables can be manipulated, with the indicators on the map image updating accordingly.

For example, mapping features include the capability to display the boundaries of census units, school attendance zones, neighborhoods, as well as statistical information such as median home values, average home age, etc.

The grid/table view allows the user to sort the list of comparables on rank, value, size, age, or any other dimension. Additionally, the rows in the table are connected to the full database entry as well as sale history for the respective property. Combined with the map view and the neighborhood statistics, this allows for a convenient yet comprehensive interactive analysis of comparable sales.

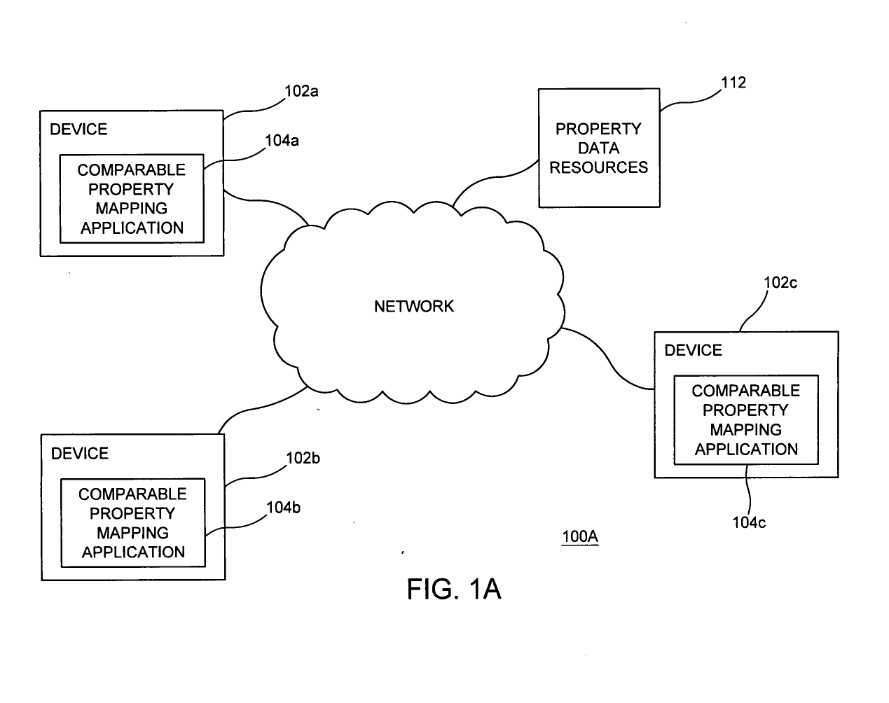

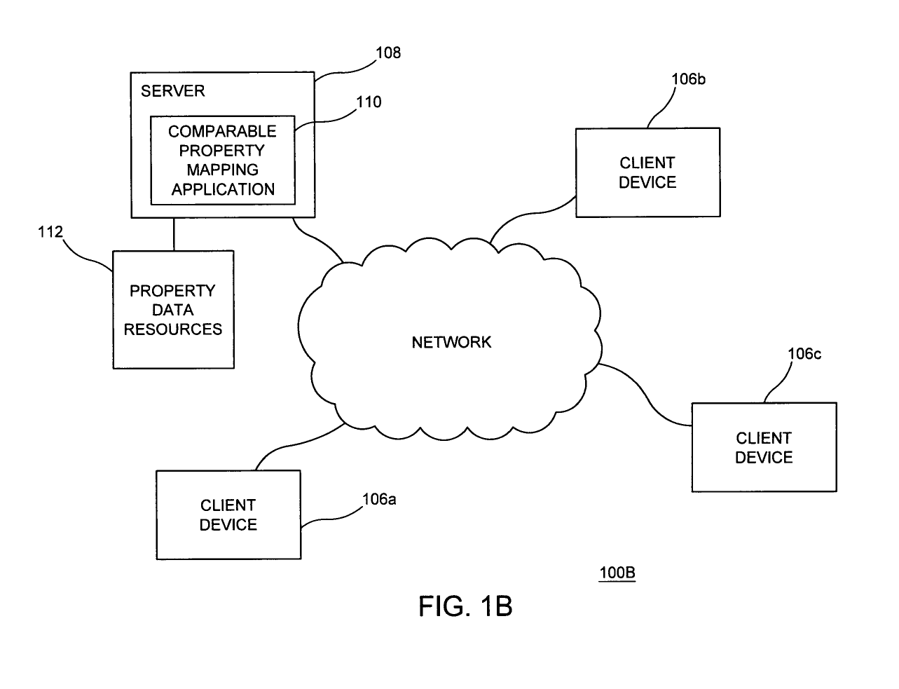

FIGS. 1A-B are block diagrams illustrating examples of systems 100A-B in which a comparable property modeling and mapping application operates.

FIG. 1A illustrates several user devices 102a-c each having a comparable property mapping application 104a-c.

The user devices 102a-d are preferably computer devices, which may be referred to as workstations, although they may be any conventional computing device. The network over which the devices 102a-d may communicate may also implement any conventional technology, including but not limited to cellular, WiFi, WLAN, LAN, or combinations thereof.

In one embodiment, the comparable property mapping application 104a-c is an application that is installed on the user device 102a-c. For example, the user device 102a-c may be configured with a web browser application, with the application configured to run in the context of the functionality of the browser application. This configuration may also implement a network architecture wherein the comparable property mapping applications 104a-c provide, share and rely upon the comparable property mapping application 104a-c functionality.

As an alternative, as illustrated in FIG. 1B, the computing devices 106a-c may respectively access a server 108, such as through conventional web browsing, with the server 108 providing the comparable property mapping application 110 for access by the client computing devices 106a-c. As another alternative, the functionality may be divided between the computing devices and server. Finally, of course, a single computing device may be independent configured to include the comparable property mapping application.

As illustrated in FIGS. 1A-B, property data resources 110 are typically accessed externally for use by the comparable property mapping application, since the amount of property data is rather voluminous, and since the application is configured to allow access to any county or local area in a very large geographical area (e.g., for an entire country such as the United States). Additionally, the property data resources 110 are shown as a singular block in the figure, but it should be understood that a variety of resources, including company-internal collected information (e.g., as collected by Fannie Mae), as well as external resources, whether resources where property data is typically found (e.g., MLS, tax, etc.), or resources compiled by an information services provider (e.g., Lexis).

The comparable property mapping application accesses and retrieves the property data from these resources in support of the modeling of comparable properties as well as the rendering of map images of subject properties and corresponding comparable properties, and the display of supportive data (e.g., in grid form) in association with the map images.

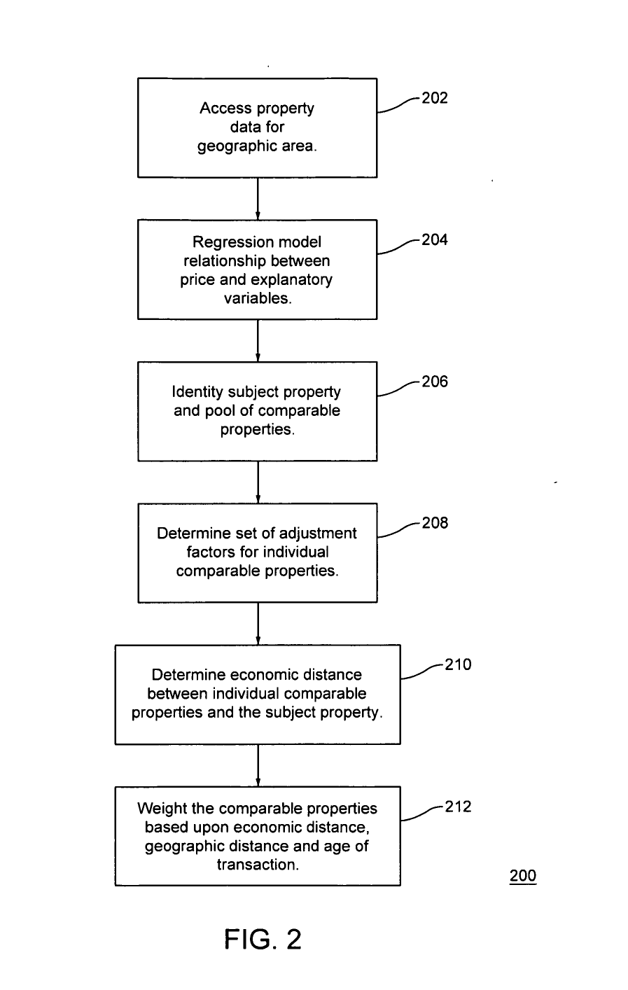

FIG. 2 is a flow diagram illustrating an example of a process 200 for modeling comparable properties, which may be performed by the comparable property mapping application.

As has been described, the application accesses 202 property data. This is preferably tailored at a geographical area of interest in which a subject property is located (e.g., county). A regression 204 modeling the relationship between price and explanatory variables is then performed on the accessed data. Although various alternatives may be applied, a preferred regression is that described above, wherein the explanatory variables are the four property characteristics (GLA, lot size, age, number of bathrooms) as well as the categorical fixed effects (location, time, foreclosure status).

A subject property within the county is identified 206 as is a pool of comparable properties. As described, the subject property may be initially identified, which dictates the selection and access to the appropriate county level data. Alternatively, a user may be reviewing several subject properties within a county, in which case the county data will have been accessed, and new selections of subject properties prompt new determinations of the pool of comparable properties for each particular subject property.

The pool of comparable properties may be initially defined using exclusion rules. This limits the unwieldy number of comparables that would likely be present if the entire county level data were included in the modeling of the comparables.

Although a variety of exclusion rules can be used, in one example they may include one or more of the following: (1) limiting the comparable properties to those within the same census tract as the subject property (or, the same census tract and any adjacent tracts); (2) including only comparable properties where the transaction (e.g., sale) is within 12 months of the effective date of the appraisal or transaction (sale); (3) requiring GLA to be within a range including that of the subject property (e.g., +/−50% of the GLA of the subject property); (4) requiring the age of the comparable properties to be within an assigned range as determined by the age of the subject property (e.g., as described previously); and/or (5) requiring the lot size for the comparable properties to be within an assigned range as determined by the lot size of the subject property (e.g., as described previously).

Once the pool is so-limited, a set of adjustment factors is determined 208 for each remaining comparable property. The adjustment factors may be a numerical representation of the price contribution of each of the explanatory variables, as determined from the difference between the subject property and the comparable property for a given explanatory variable. An example of the equations for determining these individual adjustments has been provided above.

Once these adjustment factors have been determined 208, the “economic distance” between the subject property and respective individual comparable properties is determined 210. The economic distance is preferably constituted as a quantified value representative of the estimated price difference between the two properties as determined from the set of adjustment factors for each of the explanatory variables.

Following determining of the economic distance, the comparable properties are weighted 212 in support of generating a ranking of the comparable properties according to the model. A preferred weighting, described previously, entails a function inversely proportional to the economic distance, geographic distance and age of transaction (typically sale) of the comparable property from the subject property.

The weights may further be used to calculate an estimated price of the subject property comprising a weighted average of the adjusted price of all of the comparable properties.

Once the model has performed the regression, adjustments and weighting of comparables, the information is conveyed to the user in the form of grid and map image displays to allow convenient and comprehensive review and analysis of the set of comparables.

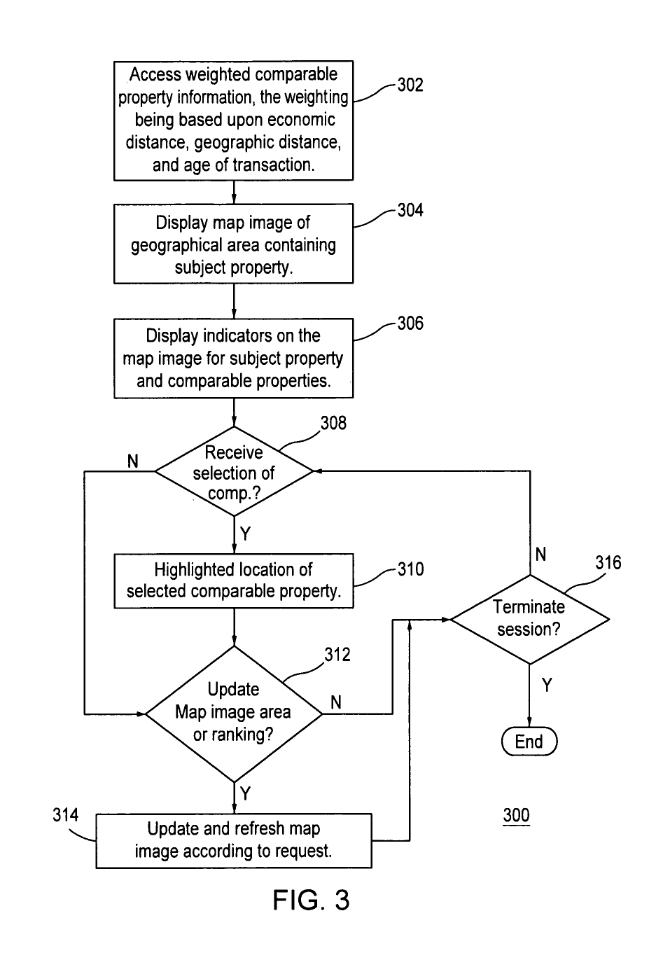

FIG. 3 is a flow diagram illustrating an example of a process 300 for modeling and mapping comparable properties with initial access 302 of the weighted comparable property information. This may be as described above, or any modeling wherein the comparable properties are weighted according to the economic distance, geographic distance and age of transaction information.

The process also includes display 304 of a map image of a geographic area containing the subject property. The map image information may be acquired from conventional mapping resources, including but not limited to Google maps and the like. Additionally, conventional techniques may be used to depict subject and comparable properties on the map image, such as through determination of the coordinates from address information.

The map imagery may be various updated to provide user-desired views, including zooming in and out to provide more narrow or broad perspectives of the depictions of the comparable and subject properties.

The property data includes information as to the location of the properties, and either this native data may be used, or it may be supplemented, to acquire that exact location of the subject property and potential comparable properties on the map image. This allows the map image to be populated with indicators that display 306 the location of the subject property and the comparable properties in visually distinguishable fashion on the map image. The number of comparable properties that are shown can be predetermined or may be configurable based upon user preferences. The number of comparable properties that are shown may also update depending upon the level of granularity of the mage image. That is, when the user updates 312 the map image such as by zooming out to encompass a wider geographical area, when the map image updates 314 additional comparable properties may be rendered in addition to those rendered at a more local range.

The user may also prompt a particular comparable property to be highlighted 310, such as by cursor rollover or selection of an entry for the comparable property in a listing. When the application receives 308 an indication that a property has been selected, it is highlighted in the map. Conversely, the user may also select the indicator for a property on the map image, which causes display of the details corresponding to the selected property.

Updating of the map image, highlighting of selected properties, and other review of the property data continues until termination (316) of the current session.

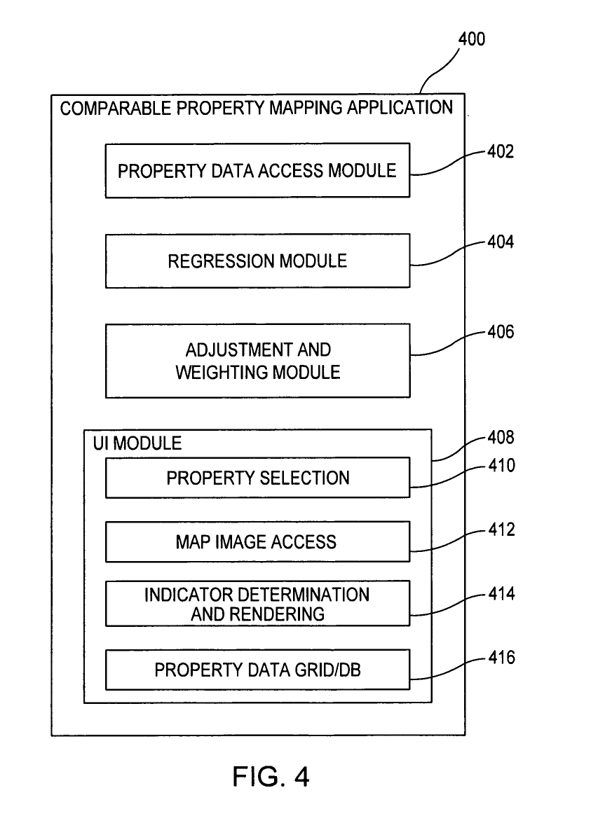

FIG. 4 is a block diagram illustrating an example of a comparable property mapping application 400. The application 400 preferably comprises program code that is stored on a computer readable medium (e.g., compact disk, hard disk, etc.) and that is executable by a processor to perform operations in support of modeling and mapping comparable properties.

According to one aspect, the application includes program code executable to perform operations of accessing property data corresponding to a geographical area, and performing a regression based upon the property data, with the regression modeling the relationship between price and explanatory variables. A subject property and a plurality of comparable properties are identified, followed by determining a set of value adjustments for each of the plurality of comparable properties based upon differences in the explanatory variables between the subject property and each of the plurality of comparable properties. An economic distance between the subject property and each of the comparable properties is determined, with the economic distance constituted as a quantified value determined from the set of value adjustments for each respective comparable property. Once the properties are identified and the adjustments are determined, there is a weighting of the plurality of comparable properties based upon the appropriateness of each of the plurality of comparable properties as comparables for the subject property, the weighting being based upon one or more of the economic distance from the subject property, geographic distance from the subject property, and age of transaction.

The application 400 also includes program code for displaying a map image corresponding to the geographical area, and displaying indicators on the map image indicative of the subject property and at least one of the plurality of comparable properties, as well as ranking the plurality of comparable properties based upon the weighting, and displaying a text listing of the plurality of comparable properties according to the ranking. Finally, the application is configured to receive input indicating selection of comparable properties and to update the map images and indicators as described.

The comparable property mapping application 400 is preferably provided as software, but may alternatively be provided as hardware or firmware, or any combination of software, hardware and/or firmware. The application 400 is configured to provide the comparable property modeling and mapping functionality described herein. Although one modular breakdown of the application 400 is offered, it should be understood that the same functionality may be provided using fewer, greater or differently named modules.

The example of the comparable property mapping application 400 of FIG. 4 includes a property data access module 402, regression module 404, adjustment and weighting module 406, and UI module 408, with the UI module 408 further including a property selection module 410, map image access module 412, indicator determining and rendering module 414 and property data grid/DB module 416.

The property data access module 402 includes program code for carrying access and management of the property data, whether from internal or external resources. The regression module 404 includes program code for carrying out the regression upon the accessed property data, according to the regression algorithm described above, and produces corresponding results such as the determination of regression coefficients and other data at the country (or other) level as appropriate for a subject property. The regression module 404 may implement any conventional code for carrying out the regression given the described explanatory variables and property data.

The adjustment and weighting module 406 is configured to apply the exclusion rules, and to calculate the set of adjustment factors for the individual comparables, the economic distance, and the weighting of the comparables.

The UI module 408 manages the display and receipt of information to provide the described functionality. It includes a property selection module 410, to manage the interfaces and input used to identify one or more subject properties, from which a determination of the corresponding geographical area is determined in support of defining the scope of the regression and other functionality. The map image access module 412 accesses mapping functions and manages the depiction of the map images as well as the indicators of the subject property and the comparable properties. The indicator determination and rendering module 414 is configured to manage which indicators should be indicated on the map image depending upon the current map image, the weighted ranking of the comparables and predetermined settings or user input. The property data grid/DB 416 manages the data set corresponding to a current session, including the subject property and pool of comparable properties. It is configured as a database that allows the property data for the properties to be displayed in a tabular or grid format, with various sorting according to the property characteristics, economic distance, geographical distance, time, etc.

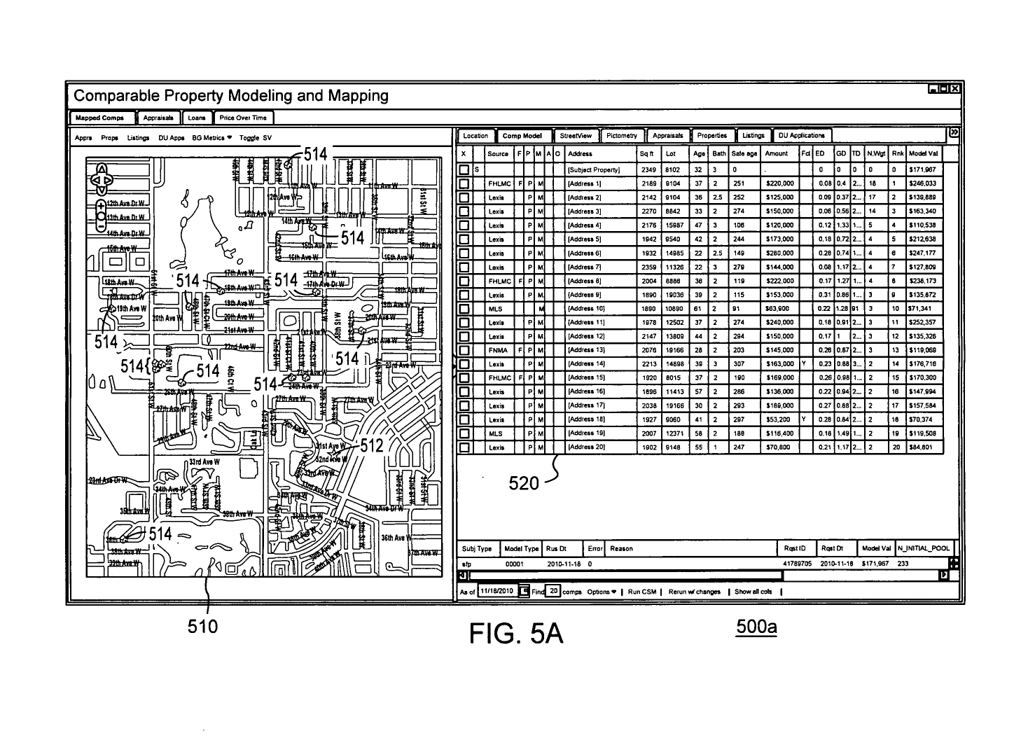

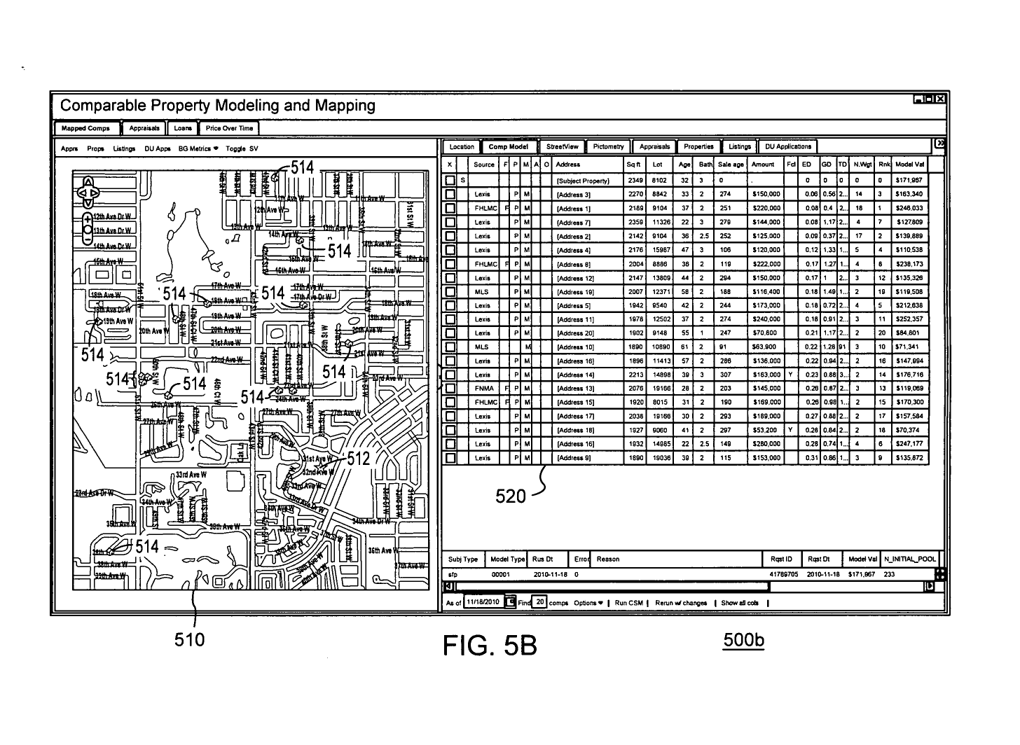

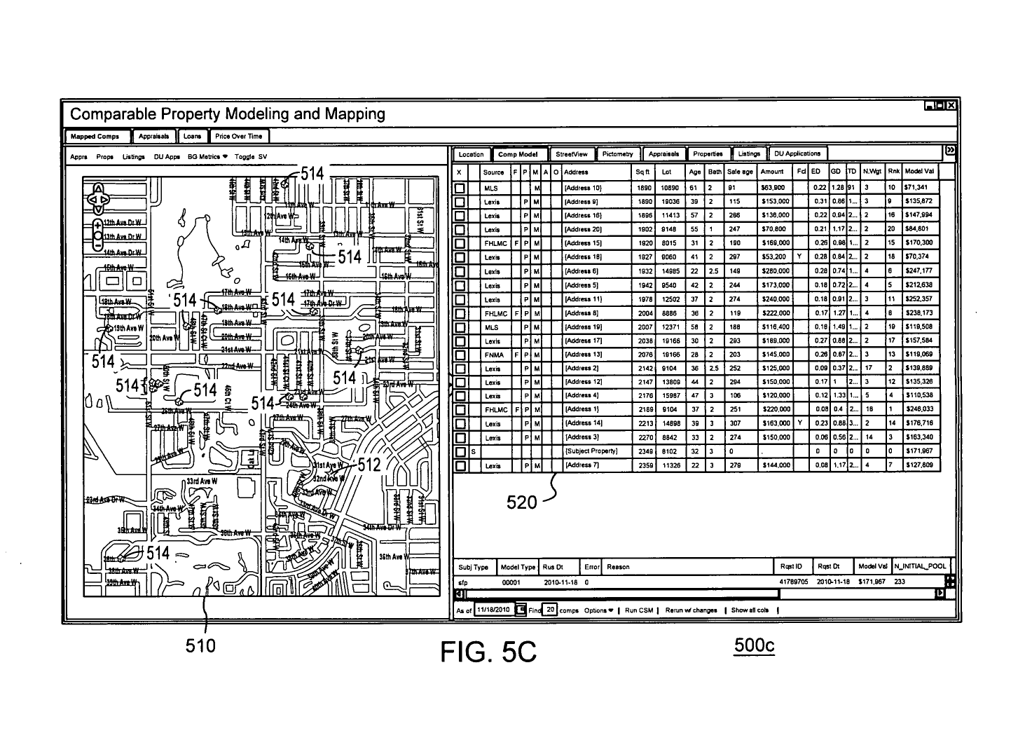

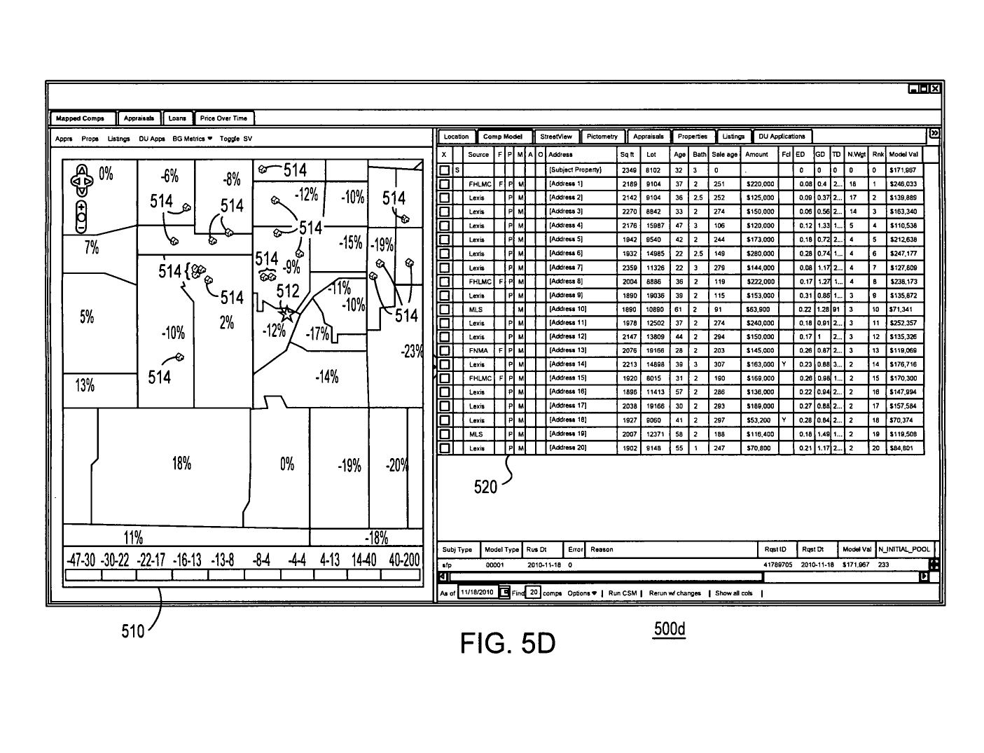

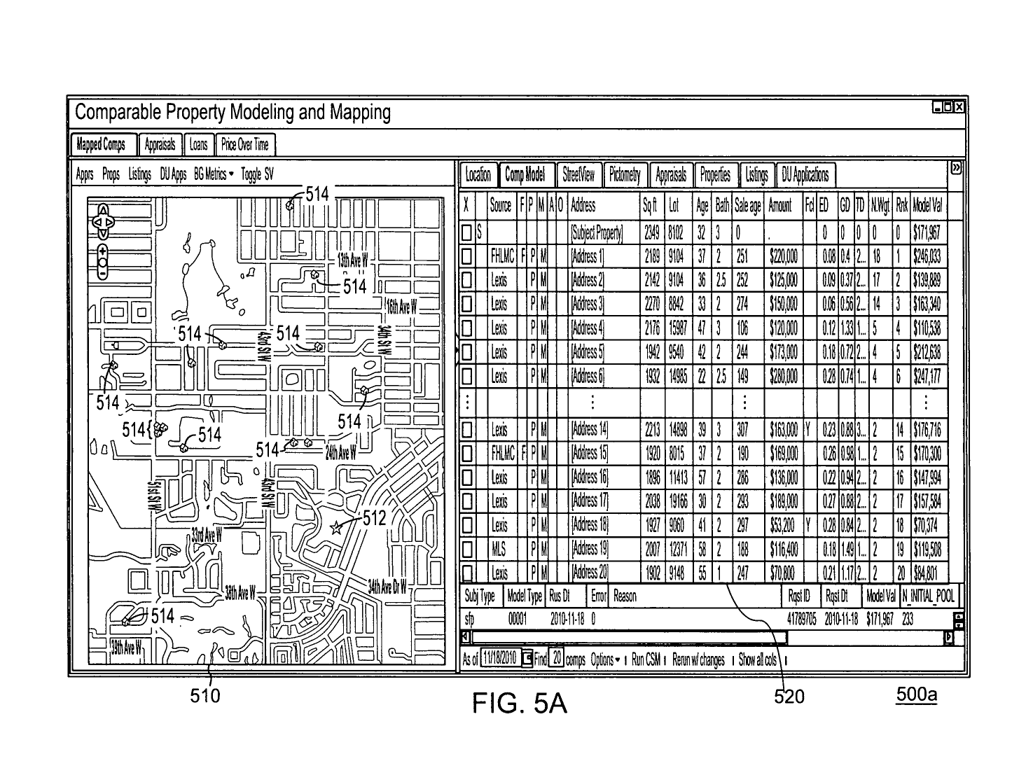

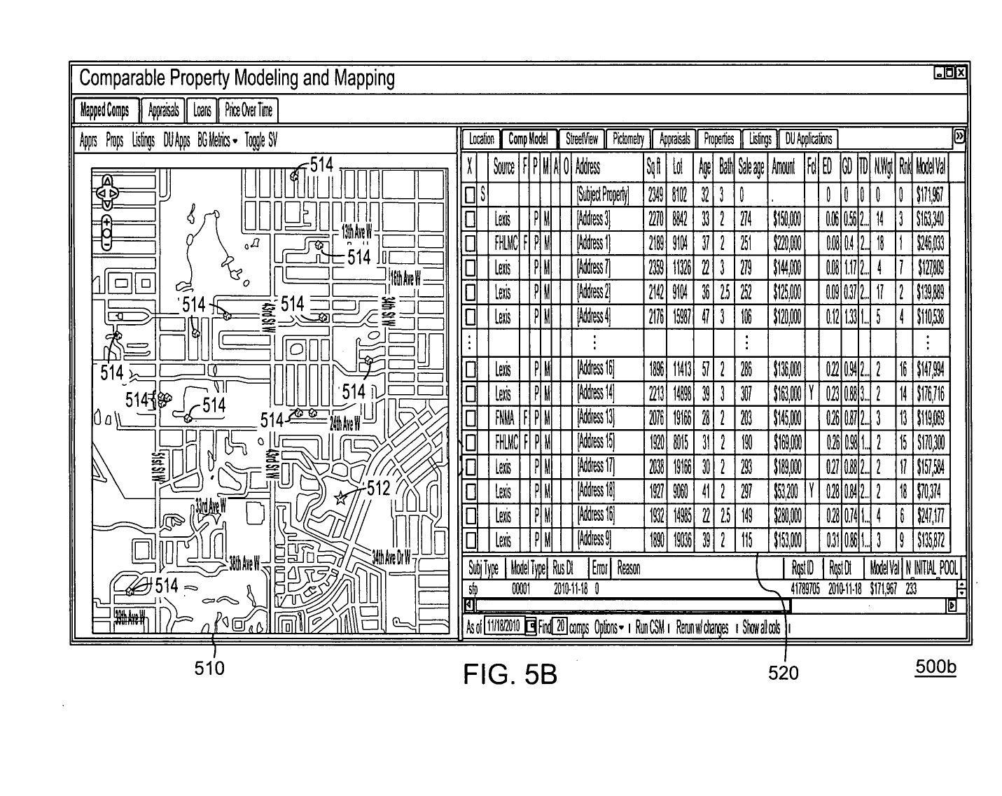

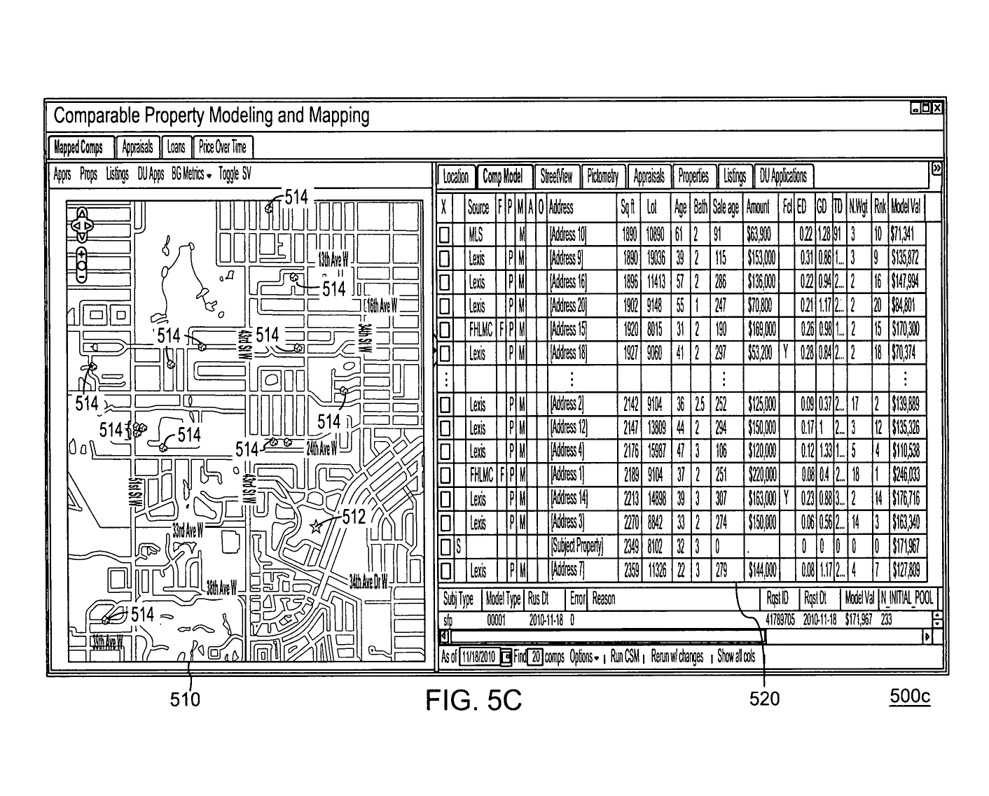

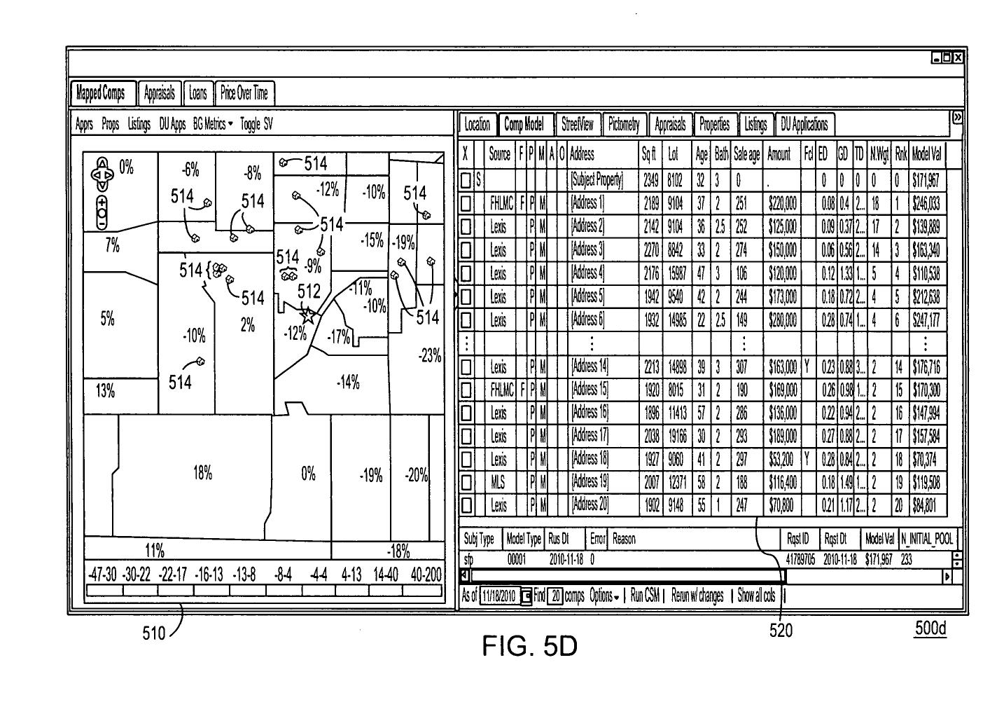

FIGS. 5A-D are display diagrams illustrating examples of map images and corresponding property grid data generated by the comparable property mapping application.

For example, FIG. 5A illustrates an example of a display screen 500a that concurrently displays a map image 510 and a corresponding property data grid 520. This screen may be displayed following selection of a subject property by a user followed by prompting a running of the comparable property model, which identifies the comparable properties, determines adjustment factors, determines economic distance and weights the comparable properties, such as described above.

The map image 510 depicts a region that can be manipulated to show a larger or smaller area, or moved to shift the center of the map image, in convention fashion. This allows the user to review the location of the subject property 512 and corresponding comps 514 at any desired level of granularity. This map image 510 may be separately viewed on a full screen, or may be illustrated alongside the property data grid 520 as shown.

The property grid data 520 contains a listing of details about the subject property and the comparable properties, as well as various information fields. The fields include an identifier field (e.g., “S” indicates the subject property), the source of data for the property (“Source”), the address of the property (“Address”), the square footage (“Sq Ft”), the lot size (“Lot”), the age of the property (“Age”), the number of bathrooms (“Bath”), the age of the prior sale (“Sale Age”), the prior sale amount (“Amount”), the foreclosure status (“FCL”, y/n), the economic distance (“ED”), geographic distance (“GD”) and time distance (“TD”, e.g., as measured in days) factors as described above, the weight (“N. Wgt”), the ranking by weight (“Rnk”), and the valuation as determined from the comparable sales model (“Model Val”).

The map image 510 allows the user to place a cursor over any of the illustrated properties to prompt highlighting of information for that property and other information. Additionally, the listing of comparables in the property grid data 520 can be updated according to any of the listed columns. For example, the display screen 500b in FIG. 5B illustrates the listing sorted by the economic distance, and the display screen 500c in FIG. 5C illustrates sorting according to the square footage of the properties. The grid data can be variously sorted to allow the user to review how the subject property compares to the listed comparable properties.

According to another aspect, the map image 510 can be divided into regions to help further assess the location of the subject property and corresponding properties. FIG. 5D illustrates the map image 510 updated to indicate several Census Block Group (CBG) regions 516 in the map image 510. The various CBGs 516 are illustrated as separated by dark lines. Additionally, within each CBG 516 the map image is updated to indicate a relative adjustment as compared to a country average for each CBG. This helps the user to further assess how the subject property relates to the comparable properties, with the CBG acting as a proxy for neighborhood.

The user may variously update the map image and manipulate the property data grid in order to review and assess and subject property and the corresponding comparable properties in a fashion that is both flexible and comprehensive.

Thus embodiments of the present invention produce and provide methods and apparatus for modeling and mapping comparable properties. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A method for modeling appropriate comparable properties, the method comprising:
accessing property data corresponding to a geographical area;
performing a regression based upon the property data, the regression modeling the relationship between price and explanatory variables;
identifying a subject property and a plurality of comparable properties;
determining a set of value adjustments for each of the plurality of comparable properties based upon differences in the explanatory variables between the subject property and each of the plurality of comparable properties; and
determining an economic distance between the subject property and each of the plurality of comparable properties, the economic distance constituted as a quantified value determined from the set of value adjustments for each respective comparable property.

2. The method of claim 1, further comprising:
weighting the plurality of comparable properties based upon the appropriateness of each of the plurality of comparable properties as comparables for the subject property, the weighting being based upon one or more of the economic distance from the subject property, geographic distance from the subject property, and age of transaction.

3. The method of claim 2, further comprising:
displaying a map image corresponding to the geographical area; and
displaying indicators on the map image indicative of the subject property and at least one of the plurality of comparable properties.

4. The method of claim 3, further comprising:
ranking the plurality of comparable properties based upon the weighting; and
displaying a text listing of the plurality of comparable properties according to the ranking.

5. The method of claim 4, further comprising:
receiving input indicating a selection of one of the plurality of comparable properties in the text listing; and
updating the indicator for the selected comparable property on the map image to highlight the location of the selected comparable property.

6. The method of claim 2, further comprising:
displaying a map image corresponding to the geographical area; and
ranking the plurality of comparable properties based upon the weighting of the plurality of comparable properties; and
displaying indicators on the map image indicative of the subject property and a subset of the plurality of comparable properties, the subset being determined according to the ranking.

7. A method for modeling appropriate comparable properties, the method comprising:
accessing property data corresponding to a geographical area;
weighting a plurality of comparable properties based upon the appropriateness of each of the plurality of comparable properties as comparables for a subject property, the weighting being based upon one or more of the economic distance from the subject property, geographic distance from the subject property, and age of transaction;
displaying a map image corresponding to the geographical area; and
displaying indicators on the map image indicative of the subject property and at least one of the plurality of comparable properties.

8. The method of claim 7, further comprising:
ranking the plurality of comparable properties based upon the weighting; and
displaying a text listing of the plurality of comparable properties according to the ranking.

9. The method of claim 8, further comprising:
receiving input indicating a selection of one of the plurality of comparable properties in the text listing; and
updating the indicator for the selected comparable property on the map image to highlight the location of the selected comparable property.

10. The method of claim 6, further comprising:
ranking the plurality of comparable properties based upon the weighting of the plurality of comparable properties; and
displaying indicators on the map image indicative of the subject property and a subset of the plurality of comparable properties, the subset being determined according to the ranking.

11. An apparatus for modeling appropriate comparable properties, the apparatus comprising:
means for accessing property data corresponding to a geographical area;
means for performing a regression based upon the property data, the regression modeling the relationship between price and explanatory variables;
means for identifying a subject property and a plurality of comparable properties;
means for determining a set of value adjustments for each of the plurality of comparable properties based upon differences in the explanatory variables between the subject property and each of the plurality of comparable properties; and
means for determining an economic distance between the subject property and each of the plurality of comparable properties, the economic distance constituted as a quantified value determined from the set of value adjustments for each respective comparable property.

12. An apparatus for modeling appropriate comparable properties, the method comprising:
means for accessing property data corresponding to a geographical area;
means for weighting a plurality of comparable properties based upon the appropriateness of each of the plurality of comparable properties as comparables for a subject property, the weighting being based upon one or more of the economic distance from the subject property, geographic distance from the subject property, and age of transaction;
means for displaying a map image corresponding to the geographical area; and
means for displaying indicators on the map image indicative of the subject property and at least one of the plurality of comparable properties.

13. A computer program product for modeling appropriate comparable properties, comprising a non-transitory computer readable medium storing program code, the program code being executable to perform operations comprising:
accessing property data corresponding to a geographical area;
performing a regression based upon the property data, the regression modeling the relationship between price and explanatory variables;
identifying a subject property and a plurality of comparable properties;
determining a set of value adjustments for each of the plurality of comparable properties based upon differences in the explanatory variables between the subject property and each of the plurality of comparable properties; and
determining an economic distance between the subject property and each of the plurality of comparable properties, the economic distance constituted as a quantified value determined from the set of value adjustments for each respective comparable property.

14. The computer program product of claim 13, wherein the operations further comprise:
weighting the plurality of comparable properties based upon the appropriateness of each of the plurality of comparable properties as comparables for the subject property, the weighting being based upon one or more of the economic distance from the subject property, geographic distance from the subject property, and age of transaction.

15. The computer program product of claim 14, wherein the operations further comprise:
displaying a map image corresponding to the geographical area; and
displaying indicators on the map image indicative of the subject property and at least one of the plurality of comparable properties.

16. The computer program produce of claim 15, wherein the operations further comprise:
ranking the plurality of comparable properties based upon the weighting; and
displaying a text listing of the plurality of comparable properties according to the ranking.

17. The computer program product of claim 16, wherein the operations further comprise:
receiving input indicating a selection of one of the plurality of comparable properties in the text listing; and
updating the indicator for the selected comparable property on the map image to highlight the location of the selected comparable property.

18. The computer program product of claim 14, wherein the operations further comprise:
displaying a map image corresponding to the geographical area; and
ranking the plurality of comparable properties based upon the weighting of the plurality of comparable properties; and
displaying indicators on the map image indicative of the subject property and a subset of the plurality of comparable properties, the subset being determined according to the ranking.

19. A computer program product for modeling appropriate comparable properties, comprising a non-transitory computer readable medium storing program code, the program code being executable to perform operations comprising:
accessing property data corresponding to a geographical area;
weighting a plurality of comparable properties based upon the appropriateness of each of the plurality of comparable properties as comparables for a subject property, the weighting being based upon one or more of the economic distance from the subject property, geographic distance from the subject property, and age of transaction;
displaying a map image corresponding to the geographical area; and
displaying indicators on the map image indicative of the subject property and at least one of the plurality of comparable properties.
